(19) United States
(12) Patent Application Publication
(10) Pub. No.: US 2025/0215123 A1
(43) Pub. Date: Jul. 3, 2025

(54) EMULSION POLYMERIZATION WITH SOLKETAL (METH)ACRYLATE

(71) Applicant: BASF SE, Ludwigshafen am Rhein (DE)

(72) Inventors: Friederike FLEISCHHAKER, Ludwigshafen am Rhein (DE); Christoph FLECKENSTEIN, Ludwigshafen am Rhein (DE); Andrea MISSKE, Ludwigshafen am Rhein (DE)

(21) Appl. No.: 18/851,155

(22) PCT Filed: Mar. 21, 2023
(86) PCT No.: PCT/EP2023/057172

§ 371 Date: Sep. 26, 2024

(30) Foreign Application Priority Data
Mar. 29, 2022 (EP) 22164968.4

(51) Int. Cl. C08F 20/28; C09D 133/10

(52) U.S. Cl. CPC C08F 20/28; C09D 133/10

(57) ABSTRACT

A process for preparing an aqueous polymer latex by polymerizing, optionally in the presence of a seed latex, a monomer composition containing solketal (meth)acrylate by radical emulsion polymerization in an aqueous polymerization medium in the presence of an acidic reacting radical polymerization initiator, wherein the monomer composition comprises a) 0.1 to 100% by weight of solketal (meth)acrylate, b) 0 to 99.9% by weight of one or more further ethylenically unsaturated monomers, characterized in that an essentially neutral pH in the range of from 6 to 8 is maintained in the aqueous polymerization medium during the radical emulsion polymerization reaction by the presence of a basic compound.

The invention concerns a process for preparing an aqueous polymer latex containing solketal (meth)acrylate as a monomer by radical emulsion polymerization, as well as the aqueous polymer latex obtained thereby and its use.

Solketal acrylate, also named (2,2-dimethyl-1,3-dioxolan-4-yl)methyl acrylate, IPGA) is known as a reactive diluent in curable compositions, such as printing inks, preferably inkjet printing inks. Solketal acrylate can be prepared by transesterification of ethyl acrylate with solketal, as described in WO 2018/146258.

Solketal (meth)acrylate has become increasingly interesting as a monomer for preparing aqueous polymer latices by radical emulsion polymerization for various applications, such as waterborne coatings, films and paints and diverse adhesives. Further application fields of the polymer latices are e.g. pigment printing, road marking, flooring or oil drilling fluids.

Zhen et al., Atom Transfer Radical Polymerization of Solketal Acrylate Using Cyclohexanone as the Solvent, Macromolecular Chemistry and Physics 206 (5), pp. 607-612, describe the homopolymerization of Solketal acrylate by atom transfer radical polymerization (ATRP) using CuBr/pentamethyldiethylenetriamine as catalyst and cyclohexanone as solvent. The prepared bromine terminated homopolymers, were used as macroinitiators to initiate polymerization of tert-butyl acrylate under similar ATRP conditions to produce diblock copolymers with controlled molecular weights and low polydispersities.

Pham et al., Glycerol-based co-oligomers by free-radical chain transfer polymerization: Towards reactive polymers bearing acetal and/or carbonate groups with enhanced properties, European Polymer Journal 95 (2017), pp. 491-502, report the synthesis of solvent-soluble oligomers from glycerin carbonate acrylate and solketal acrylate by free-radical chain transfer polymerization using 2-mercaptoethanol as chain transfer agent.

WO2017/191167 discloses an aqueous polymer latex that is used as binder in waterborne coating compositions containing a titanium dioxide pigment. The aqueous polymer latex is obtained by polymerizing a monomer composition M by radical emulsion polymerization using a specific feed method, where the monomer composition M consists of
a) 80 to 99.95% by weight, based on the total weight of the monomer composition M, of ethylenically unsaturated monomers M1, which are selected from mixtures of at least one monomer M1a, selected from C₁-C₂₀-alkyl esters of acrylic acid and C₅-C₂₀-alkylesters of methacrylic acid; and at least one monomer M1b, selected from vinyl aromatic monomers and C₁-C₄-alkyl esters of methacrylic acid;
b) 0.05 to 5% by weight, based on the total weight of the monomer composition M, of one or more monoethylenically unsaturated monomers M2, which are selected from monoethylenically unsaturated monocarboxylic acids having 3 to 6 carbon atoms and monoethylenically unsaturated dicarboxylic acids having 4 to 6 carbon atoms;
c) 0 to 20% by weight of non-ionic monomers M3, which are different from monomers M1, such as hydroxy-C₂-C₄-alkylesters of acrylic acid and methacrylic acid.

The aqueous polymer latex is used as a binder in an aqueous coating composition containing a titanium dioxide pigment.

The free-radically initiated aqueous emulsion polymerization is triggered by means of a free-radical polymerization initiator (free-radical initiator). These are in principle peroxides, persulfates, azo compounds and redox initiator systems. The peroxides can be inorganic peroxides or organic peroxides. Some of the radical polymerization initiators, especially inorganic persulfates, react acidic when they are contacted with water. They produce an acidic pH of below 6 when dissolved in an aqueous reaction medium, especially under elevated temperatures.

It is an object of the present invention to provide a process for the preparation of an aqueous polymer latex containing solketal (meth)acrylate as a monomer by radical emulsion polymerization using an acidic reacting polymerization initiator, such as persulfates.

The problem is solved by a process for preparing an aqueous polymer latex by polymerizing, optionally in the presence of a seed latex, a monomer composition containing solketal (meth)acrylate by radical emulsion polymerization in an aqueous polymerization medium in the presence of an acidic reacting radical polymerization initiator, wherein the monomer composition comprises
a) 0.1 to 100% by weight of solketal (meth)acrylate,
b) 0 to 99.9% by weight of one or more further ethylenically unsaturated monomers,

characterized in that an essentially neutral pH in the range of from 6 to 8 is maintained in the aqueous polymerization medium during the radical emulsion polymerization by the presence of a basic compound.

Solketal (meth)acrylate is an abbreviation for solketal acrylate and solketal methacrylate. Solketal acrylate is preferred.

The further ethylenically unsaturated monomers may be selected from the group b1) consisting of C₁-C₂₀-alkyl esters of acrylic acid or methacrylic acid.

The term C₁-C₂₀ alkyl denominates a group of linear or branched or cyclic saturated hydrocarbon radicals having from 1 to 20 carbon atoms. Examples of alkyl include but are not limited to methyl, ethyl, n-propyl, isopropyl, n-butyl, sec butyl, isobutyl, tert-butyl, pentyl, 1-methylbutyl, 2-methylbutyl, 3-methylbutyl, 2,2 dimethylpropyl, 1-ethylpropyl, hexyl, 1,1-dimethylpropyl, 1,2-dimethylpropyl, 1 methylpentyl, 2-methylpentyl, 3 methylpentyl, 4-methylpentyl, 1,1-dimethylbutyl, 1,2 dimethylbutyl, 1,3-dimethylbutyl, 2,2-dimethylbutyl, 2,3-dimethylbutyl, 3,3 dimethylbutyl, 1-ethylbutyl, 2-ethylbutyl, 1,1,2-trimethylpropyl, 1,2,2-trimethylpropyl, 1-ethyl-1-methylpropyl, 1-ethyl-2-methylpropyl, n-heptyl, 2-heptyl, n-octyl, 2-octyl, isooctyl, 2-ethylhexyl, 2-propylheptyl, nonyl, decyl, undecyl, dodecyl, tridecyl, tetradecyl, pentadecyl, hexadecyl, heptadecyl, octadecyl, nonadecyl, eicosyl, heneicosyl docosyl and in case of nonyl, decyl, undecyl, dodecyl, tridecyl, tetradecyl, pentadecyl, hexadecyl, heptadecyl, octadecyl, nonadecyl, eicosyl, heneicosyl docosyl their isomers,

cyclopentyl, cyclohexyl, methylcyclohexyl, dimethylcyclohexyl, cycloheptyl, cyclooctyl, cyclododecyl, cyclohexadecyl, norbomyl (=bicyclo[2.2.1]heptyl) and isobornyl (=1,7,7-trimethylbicyclo[2.2.1]heptyl).

In particular tert-butyl (meth)acrylate, n-butyl (meth)acrylate, isobutyl (meth)acrylate, 2-propylheptyl meth)acrylate, cyclohexyl (meth)acrylate, n-octyl (meth)acrylate, 2-octyl (meth)acrylate, 2-ethylhexyl (meth)acrylate, methyl (meth)acrylate are used as monomers b1).

(Meth)acrylate is an abbreviation for acrylate and methacrylate.

The further ethylenically unsaturated monomers may be selected from the group b2) consisting of vinyl esters, in particular vinyl acetate, vinyl propionate, vinyl laurate, vinyl neodecanoate, vinyl esters of versatic acid and vinyl ester of 2-ethyl hexanoic acid.

The further ethylenically unsaturated monomers may be selected from the group b3) consisting of vinyl aromatic monomers, in particular styrene.

The further ethylenically unsaturated monomers may be selected from the group b4) consisting of
monoethylenically unsaturated monocarboxylic acids having 3 to 6 carbon atoms, such as acrylic acid, methacrylic acid, crotonic acid, 2-ethylpropenoic acid, 2 propylpropenoic acid, 2-acryloxyacetic acid and 2-methacryloxyacetic acid;
monoethylenically unsaturated dicarboxylic acids having 4 to 6 carbon atoms, such as itaconic acid, citraconic acid, maleic acid and fumaric acid;
semi-esters of monoethylenically unsaturated dicarboxylic acids having 4 to 6 carbon atoms, with C₁-C₄ alkanols, such as methanol or ethanol, such as semi-esters of itaconic acid, citraconic acid, maleic acid or fumaric acid with methanol or ethanol;
monoethylenically unsaturated sulfonic acids, such as vinylsulfonic acid, allyisulfonic acid, styrenesulfonic acid, 2-acrylamido-2-methylpropane sulfonic acid;
monoethylenically unsaturated phosphonic acids such as vinylphosphonic acid, allylphosphonic acid, styrenephosphonic acid and 2-acrylamido-2-methylpropane phosphonic acid; and
monoethylenically unsaturated phosphoric acids such as monophosphates of hydroxyalkyl acrylates, monophosphates of hydroxyalkyl methacrylates, monophosphates of alkoxylated hydroxyalkyl acrylates and monophosphates of alkoxylated hydroxyalkyl methacrylates, in particular monophosphates of hydroxyethyl acrylate, hydroxypropyl acrylate or hydroxybutyl acrylate, monophosphates of hydroxyethyl methacrylate, hydroxypropyl methacrylate or hydroxybutyl methacrylate, monophosphates of ethoxylated hydroxy-C₂-C₄-alkyl acrylates, monophosphates of propoxylated hydroxy-C₂-C₄-alkyl acrylates, monophosphates of ethoxylated hydroxy-C₂-C₄-alkyl methacrylates and monophosphates of propoxylated hydroxy-C₂-C₄-alkyl methacrylates.

Preferred monomers b4) are acrylic acid, methacrylic acid, maleic acid, half methyl ester of maleic acid, half ethyl ester of maleic acid, citraconic acid, half methyl ester of citraconic acid, itaconic acid, half methyl ester of itaconic acid, fumaric acid, half methyl ester of fumaric acid, and half ethyl ester of fumaric acid.

The further ethylenically unsaturated monomers may be selected from the group b5) consisting of
primary amides of monoethylenically unsaturated monocarboxylic acids having 3 to 8 carbon atoms such as acrylamide and methacrylamide;
N—C₁-C₁₀ alkyl amides of monoethylenically unsaturated monocarboxylic acids having 3 to 6 carbon atoms, in particular N—C₁-C₁₀ alkyl amides of acrylic acid or methacrylic acid, such as N-methyl acrylamide, N-ethyl acrylamide, N-propyl acrylamide, N-isopropyl acrylamide, N-butyl acrylamide, N-methyl methacrylamide, N-ethyl methacrylamide, N-propyl methacrylamide, N-isopropyl methacrylamide and N-butyl methacrylamide;
N-hydroxy-C₁-C₁₀ alkyl amides of monoethylenically unsaturated monocarboxylic acids having 3 to 6 carbon atoms, in particular N-hydroxy-C₁-C₁₀ alkyl amides of acrylic acid or methacrylic acid, such as N-hydroxymethyl acrylamide,
monoethylenically unsaturated monomers bearing urea or keto groups, such as 2-(2-oxoimidazolidin-1-yl)ethyl (meth)acrylate, 2-ureido (meth)acrylate, N-[2-(2-oxooxazolidin-3-yl)ethyl]methacrylate, acetoacetoxyethyl acrylate, acetoacetoxypropyl methacrylate, acetoacetoxybutyl methacrylate, 2-(acetoacetoxy) ethyl methacrylate, diacetoneacrylamide (DAAM) and diacetonemethacrylamide;
hydroxyalkyl esters of monoethylenically unsaturated C₃-C₆ monocarboxylic acids, especially hydroxyalkyl esters of acrylic acid and hydroxyalkyl esters of methacrylic acid, also referred to hereinafter as hydroxyalkyl (meth)acrylates, in particular hydroxy-C₂-C₄-alkylesters of acrylic acid and hydroxy-C₂-C₄-alkylesters of methacrylic acid, such as 2-hydroxyethyl acrylate, 3-hydroxypropyl acrylate, 4-hydroxybutyl acrylate, 2-hydroxyethyl methacrylate, 3-hydroxypropyl methacrylate and 4-hydroxybutyl methacrylate; and
monoethylenically unsaturated monomers which bear at least one tri-C₁-C₄-alkoxysilane group such as vinyl trimethoxysilane, vinyl triethoxysilane, methacryloxyethyl trimethoxysilane, methacryloxyethyl triethoxysilane.

Preferred monomers b5) are acrylamide, methacrylamide, N-hydroxymethyl acrylamide 2-hydroxyethyl acrylate, ureido methacrylate and 4-hydroxybutyl acrylate.

The further ethylenically unsaturated monomers may be selected from the group b6) consisting of
diesters of monoethylenically unsaturated C₃-C₆ monocarboxylic acids with saturated aliphatic or cycloaliphatic diols, in particular diesters of acrylic acid or methacrylic acid, such as the diacrylates and the dimethacrylates of ethylene glycol (1,2-ethanediol), propylene glycol (1,2-propanediol), 1,2-butanediol, 1,3-butanediol, 1,4-butanediol, neopentyl glycol (2,2-dimethyl-1,3-propanediol) and 1,2-cyclohexanediol;
monoesters of monoethylenically unsaturated C₃-C₆ monocarboxylic acids with monoethylenically unsaturated aliphatic or cycloaliphatic monohydroxy compounds, such as the acrylates and the methacrylates of vinyl alcohol (ethenol), allyl alcohol (2-propen-1-ol), 2-cyclohexen-1-ol or norbomenol; and
divinyl aromatic compounds, such as 1,3-divinyl benzene and 1,4-divinyl benzene.

In some embodiments, the monomer composition comprises
a) 1 to 99% by weight of solketal (meth)acrylate,
b) 1 to 99% by weight of one or more further ethylenically unsaturated monomers.

In some particular embodiments, the monomer composition comprises
a) 5 to 50% by weight of solketal (meth)acrylate,
b) 50 to 95% by weight of one or more further ethylenically unsaturated monomers.

In some other particular embodiments, the monomer composition comprises
a) 1 to 20% by weight of solketal (meth)acrylate,
b) 80 to 99% by weight of one or more further ethylenically unsaturated monomers.

In some other particular embodiments, the monomer composition comprises
a) 50 to 95% by weight of solketal (meth)acrylate,
b) 5 to 50% by weight of one or more further ethylenically unsaturated monomers.

In some other particular embodiments, the monomer composition comprises
a) 80 to 99% by weight of solketal (meth)acrylate,
b) 1 to 20% by weight of one or more further ethylenically unsaturated monomers.

In some particular embodiments, the further ethylenically unsaturated monomers are selected from one or more of groups b1), b2) b3), b4), b5) and b6).

The process for the preparation of the polymer latex is performed according to the well-known processes of radical emulsion polymerisation technology. The conditions required for the performance of the free-radical emulsion polymerization of the monomers are sufficiently familiar to those skilled in the art, for example from the prior art cited at the outset and from “Emulsions-polymerisation” [Emulsion Polymerization] in Encyclopedia of Polymer Science and Engineering, vol. 8, pages 659 ff. (1987); D. C. Blackley, in High Polymer Latices, vol. 1, pages 35 ff. (1966); H. Warson, The Applications of Synthetic Resin Emulsions, chapter 5, pages 246 ff. (1972); D. Diederich, Chemie in unserer Zeit 24, pages 135 to 142 (1990); Emulsion Polymerdsation, Interscience Publishers, New York (1965); DE-A 40 03 422 and Dispersionen synthetischer Hochpolymere [Dispersions of Synthetic High Polymers], F. Holscher, Springer-Verlag, Berlin (1969).

However, according to the present invention, it is essential that the radical emulsion polymerization is carried out by maintaining in the aqueous polymerization medium an essentially neutral pH from pH 6 to 8, preferably pH 6.5 to 7.5, in the course of the polymerization reaction by the presence of a basic compound in the aqueous polymerization medium.

The free-radically initiated aqueous emulsion polymerization is initiated by means of a free-radical polymerization initiator (free-radical initiator). These are in principle peroxides, persulfates, azo compounds and redox initiator systems.

According to the present invention, the free-radical polymerization initiator is an acidic reacting polymerization initiator that in general causes an acidic pH of <6, preferably ≤4, for example from 2 to 4 when dissolved in water. The free-radical polymerization initiator may react acidic in particular at elevated temperatures.

Preferred acidic reacting radical polymerization initiators used according to the invention are persulfates. Preferred persulfates are sodium persulfate, potassium persulfate and ammonium persulfate. They are inexpensive and commonly used in industrial processes.

In general, the essentially neutral pH of the aqueous polymerization medium is maintained by adding a basic compound to the aqueous polymerization medium during the polymerization reaction. In some embodiments of the inventive process, part or the entire amount of the basic compound is initially charged with the aqueous polymerization medium to the reaction vessel.

Preferably, the basic compound is selected from water-soluble hydroxides, oxides, carbonates, hydrogen carbonates (bicarbonates), acetates, citrates, borates, phosphates, hydrogen phosphates of alkali or alkaline earth metals or ammonium. Other basic compounds are also possible, like ammonia or water-soluble organic amines such as lower aliphatic amines.

Preferred basic compounds are the hydroxides of sodium, potassium and ammonium, the carbonates of sodium and potassium and hydrogen carbonates (bicarbonates) of sodium and potassium.

The basic compound is preferably dissolved in water.

In an embodiment, the amount of free-radical initiator for the emulsion polymerization is initially charged in the polymerization vessel completely. However, it is preferred to charge none of or merely a portion of the acidic reacting free-radical initiator, e.g. not more than 40% by weight, especially not more than 15% by weight, based on the total amount of the free-radical initiator required in the aqueous polymerization medium.

The basic compound or a part of the basic compound can also be initially charged to the polymerization vessel to achieve an essentially neutral pH from 6 to 8 in the aqueous reaction mixture, if necessary. This is in general not necessary if none of the free-radical initiator is charged, and the pH of the initially charged reaction mixture is already between pH 6-8. Then, under polymerization conditions, during the free-radical emulsion polymerization of the monomers the entire amount or any remaining residual amount of the basic component is added, according to the consumption, batchwise in one or more portions or continuously with constant or varying flow rates, in order to maintain an essentially neutral pH from 6 to 8 in the aqueous polymerization medium.

Preferably the basic compound is dissolved in water and added as described above as aqueous solution.

In another preferred embodiment, the free-radical aqueous emulsion polymerization of the invention is conducted at temperatures in the range from 0 to 170° C., more preferably in the range from 50 to 100° C., most preferably in the range from 60 to 100° C. and in particularly the free-radical aqueous emulsion polymerization of the invention is conducted at temperatures in the range from 70 to 100° C. The free-radical aqueous emulsion polymerization can be conducted at a pressure of less than, equal to or greater than 1 atm (101325 Pa).

In certain embodiments, the polymerization is conducted in the presence of a chain transfer agent. The chain transfer agents are selected from the group consisting of aliphatic and/or araliphatic halogen compounds, for example n-butyl chloride, n-butyl bromide, n-butyl iodide, methylene chloride, ethylene dichloride, chloroform, bromoform, bromotrichloromethane, dibromodichloromethane, carbon tetrachloride, carbon tetrabromide, benzyl chloride, benzyl bromide; organic thio compounds such as primary, secondary or tertiary aliphatic thiols, for example ethanethiol, n-propanethiol, 2-propanethiol, n-butanethiol, 2-butanethiol, 2-methyl-2-propanethiol, n-pentanethiol, 2-pentanethiol, 3-pentanethiol, 2-methyl-2-butanethiol, 3-methyl-2-butanethiol, n-hexanethiol, 2-hexanethiol, 3-hexanethiol, 2-methyl-2-pentanethiol, 3-methyl-2-pentanethiol, 4-methyl-2-pentanethiol, 2-methyl-3-pentanethiol, 3-methyl-3-pentanethiol, 2-ethylbutanethiol, 2-ethyl-2-butanethiol, n-heptanethiol and the isomeric compounds thereof, n-octanethiol and the isomeric compounds thereof, n-nonanethiol and the isomeric compounds thereof, n-decanethiol and the isomeric compounds thereof, n-undecanethiol and the isomeric compounds thereof, n-dodecanethiol and the isomeric compounds thereof, n-tridecanethiol and isomeric compounds thereof, substituted thiols, for example 2-hydroxyethanethiol, aromatic thiols such as benzenethiol, ortho-, meta- or para-methylbenzenethiol, alkylesters of mercaptoacetic acid (thioglycolic acid) such as 2-ethylhexyl thioglycolate, alkylesters of mercaptopropionic acid such as octyl mercapto propionate, and also further sulfur compounds described in Polymer Handbook, 3rd edition, 1989, J. Brandrup and E. H. Immergut, John Wiley & Sons, section II, pages 133 to 141, and aliphatic and/or aromatic aldehydes such as acetaldehyde, propionaldehyde and/or benzaldehyde, unsaturated fatty acids such as oleic acid, dienes having nonconjugated double bonds, such as divinylmethane or vinylcyclohexane, or hydrocarbons having readily abstractable hydrogen atoms, for example toluene.

In general, the total amount of chain transfer agents, if present, does not exceed 1% by weight, based on the total amount of monomers.

In general, the radical emulsion polymerization is conducted in presence of a surfactant. The surfactant can be selected from emulsifiers and protective colloids. The protective colloids, as opposed to emulsifiers, are understood to mean polymeric compounds having molecular weights above 2000 Daltons, whereas emulsifiers typically have lower molecular weights. The surfactants may be anionic or nonionic or mixtures of non-ionic and anionic surfactants.

The anionic surfactants usually bear at least one anionic group, which is selected from phosphate, phosphonate, sulfate and sulfonate groups. The anionic surfactants, which bear at least one anionic group, are typically used in the form of their alkali metal salts, especially of their sodium salts or in the form of their ammonium salts.

In preferred embodiments, the anionic surfactants are anionic emulsifiers, which bear in particular at least one sulfate or sulfonate group. Likewise, anionic emulsifiers, which bear at least one phosphate or phosphonate group may be used, either as sole anionic emulsifiers or in combination with one or more anionic emulsifiers, which bear at least one sulfate or sulfonate group. Examples of anionic emulsifiers, which bear at least one sulfate or sulfonate group, are, for example, the salts, especially the alkali metal and ammonium salts, of alkyl sulfates, especially of C₈-C₂₂-alkyl sulfates, the salts, especially the alkali metal and ammonium salts, of sulfuric monoesters of ethoxylated alkanols, especially of sulfuric monoesters of ethoxylated C₈-C₂₂-alkanols, preferably having an ethoxylation level (EO level) in the range from 2 to 40, the salts, especially the alkali metal and ammonium salts, of sulfuric monoesters of ethoxylated alkylphenols, especially of sulfuric monoesters of ethoxylated C₄-C₁₈-alkylphenols (EO level preferably 3 to 40), the salts, especially the alkali metal and ammonium salts, of alkylsulfonic acids, especially of C₈-C₂₂-alkylsulfonic acids, the salts, especially the alkali metal and ammonium salts, of dialkyl esters, especially di-C₁-C₁₈-alkyl esters of sulfosuccinic acid, the salts, especially the alkali metal and ammonium salts, of alkylbenzenesulfonic acids, especially of C₄-C₂₂-alkyl-benzenesulfonic acids, and—the salts, especially the alkali metal and ammonium salts, of mono- or disulfonated, alkyl-substituted diphenyl ethers, for example of bis(phenylsulfonic acid) ethers bearing a C₄-C₂₄-alkyl group on one or both aromatic rings. The examples are described in U.S. Pat. No. 4,269,749, and Dowfax® 2A1 (Dow Chemical Company).

In particularly preferred embodiments, the anionic surfactants are anionic emulsifiers, which are selected from the following groups:
the salts, especially the alkali metal and ammonium salts, of alkyl sulfates, especially of C₈-C₂₂-alkyl sulfates,
the salts, especially the alkali metal salts, of sulfuric monoesters of ethoxylated alkanols, especially of sulfuric monoesters of ethoxylated C₈-C₂₂-alkanols, preferably having an ethoxylation level (EO level) in the range from 2 to 40,
sulfuric monoesters of ethoxylated alkylphenols, especially of sulfuric monoesters of ethoxylated C₄-C₁₈-alkylphenols (EO level preferably 3 to 40), of alkylbenzenesulfonic acids, especially of C₄-C₂₂-alkylbenzenesulfonic acids, and
mono- or disulfonated, alkyl-substituted diphenyl ethers, for example of bis(phenylsulfonic acid) ethers bearing a C₄-C₂₄-alkyl group on one or both aromatic rings.

Examples of anionic emulsifies, which bear a phosphate or phosphonate group, include, but are not limited to the following salts are selected from the following groups:
the salts, especially the alkali metal and ammonium salts, of mono- and dialkyl phosphates, especially C₈-C₂₂-alkyl phosphates,
the salts, especially the alkali metal and ammonium salts, of phosphoric monoesters of C₂-C₃-alkoxylated alkanols, preferably having an alkoxylation level in the range from 2 to 40, especially in the range from 3 to 30, for example phosphoric monoesters of ethoxylated C₈-C₂₂-alkanols, preferably having an ethoxylation level (EO level) in the range from 2 to 40, phosphoric monoesters of propoxylated C₈-C₂₂-alkanols, preferably having a propoxylation level (PO level) in the range from 2 to 40, and phosphoric monoesters of ethoxylated-co-propoxylated C₈-C₂₂-alkanols, preferably having an ethoxylation level (EO level) in the range from 1 to 20 and a propoxylation level of 1 to 20,
the salts, especially the alkali metal and ammonium salts, of phosphoric monoesters of ethoxylated alkylphenols, especially phosphoric monoesters of ethoxylated C₄-C₁₈-alkylphenols (EO level preferably 3 to 40),
the salts, especially the alkali metal and ammonium salts, of alkylphosphonic acids, especially C₈-C₂₂-alkylphosphonic acids, and
the salts, especially the alkali metal and ammonium salts, of alkylbenzenephosphonic acids, especially C₄-C₂₂-alkylbenzenephosphonic acids.

Further suitable anionic surfactants can be found in Houben-Weyl, Methoden der organischen Chemie [Methods of Organic Chemistry], volume XIV/1, Makromolekulare Stoffe [Macromolecular Substances], Georg-Thieme-Verlag, Stuttgart, 1961, p. 192-208.

In other preferred embodiments, the surfactant comprises at least one anionic emulsifier, which bears at least one sulfate or sulfonate group. The at least one anionic emulsifier, which bears at least one sulfate or sulfonate group, may be the sole type of anionic emulsifiers. However, mixtures of at least one anionic emulsifier, which bears at least one sulfate or sulfonate group, and at least one anionic emulsifier, which bears at least one phosphate or phosphonate group, may also be used. In such mixtures, the amount of the at least one anionic emulsifier, which bears at least one sulfate or sulfonate group, is preferably at least 50% by weight, based on the total weight of anionic surfactants used in the process of the present invention. In particular, the amounts of anionic emulsifiers, which bear at least one phosphate or phosphonate group do not exceed 20% by weight, based on the total weight of anionic surfactants used in the process of the present invention.

In other preferred embodiments, the surfactant may also comprise one or more nonionic surface-active substances, which are especially selected from nonionic emulsifiers. Suitable nonionic emulsifiers are e.g. araliphatic or aliphatic nonionic emulsifiers, for example ethoxylated mono-, di- and trialkylphenols (EO level 3 to 50, alkylchain: C₄-C₁₀), ethoxylates of long-chain alcohols (EO level: 3 to 100, alkyl chain: C₈-C₃₆), and polyethylene oxide/polypropylene oxide homo- and copolymers. These may comprise the alkylene oxide units copolymerized in random distribution or in the form of blocks. Very suitable examples are the EO/PO block copolymers. Preference is given to ethoxylates of long-chain alkanols (alkyl chain C₁-C₃₀, mean ethoxylation level 5 to 100) and, among these, particular preference is given to those having a C₁₂-C₂₀ alkyl chain and a mean ethoxylation level of 5 to 20, and also to ethoxylated monoalkylphenols. Preferably, the surfactants used in the process of the present invention comprise less than 60% by weight, especially not more than 50% by weight, of nonionic surfactants, based on the total amount of surfactants used in the process of the present invention.

In other embodiments, the surfactants used in the process of the present invention comprise at least one anionic surfactant and at least one nonionic surfactant, the ratio of anionic surfactants to non-ionic surfactants being usually in the range from 0.5:1 to 10:1, in particular from 1:1 to 5:1.

In other preferred embodiments, the surfactant/surfactants will be used in such an amount that the amounts of surfactant/surfactants are in the range from 0.2% to 5% by weight, especially in the range from 0.5% to 3% by weight, based on the monomers to be polymerized.

The aqueous reaction medium in polymerization may in principle also comprise minor amounts (≤5% by weight) of water-soluble organic solvents, for example methanol, ethanol, isopropanol, butanols, pentanols, but also acetone, etc. Preferably, however, the process of the invention is conducted in the absence of such solvents.

In general, the aqueous polymer dispersions obtained have polymer solid contents in the range from 10% to 70% by weight, preferably 20% to 65% by weight, more preferably 30% to 60% by weight, and most preferably 40% to 60% by weight, based in each case on the total weight of the aqueous polymer dispersion.

It has been found advantageous to perform the free-radical emulsion polymerization in the presence of a seed latex. A seed latex is a polymer latex which is present in the aqueous polymerization medium before the metering of the solketal (meth)acrylate and optionally the further monomers is started. The seed latex may help to better adjust the particle size of the final polymer latex obtained in the free-radical emulsion polymerization of the invention.

Principally every polymer latex may serve as a seed latex. For the purpose of the invention, preference is given to seed latices, where the particle size of the polymer particles is comparatively small. The Z average particle diameter of the polymer particles of the seed latex, as determined by dynamic light scattering at 20° C. is preferably in the range from 10 to 80 nm, in particular from 10 to 50 nm. Preferably, the polymer particles of the seed latex are made of ethylenically unsaturated monomers, which comprise at least 95% by weight, based on the total weight of the monomers forming the seed latex, of one or more monomers selected from C₂-C₁₀-alkyl esters of acrylic acid, in particular ethyl acrylate, n-butyl acrylate, 2-ethyl-hexylacrylate, C₁-C₄-alkyl esters of methacrylic acid, in particular methyl methacrylate, and vinylaromatic monomers, in particular styrene.

For this, the seed latex is usually charged into the polymerisation vessel before the metering of solketal (meth)acrylate and optionally the further monomers is started. In particular, the seed latex is charged into the polymerisation vessel followed by establishing the polymerization conditions and charging at least a portion of the free-radical initiator into the polymerisation vessel before the metering of solketal (meth)acrylate and optionally the further monomers is started.

The amount of seed latex, calculated as solids, may frequently be in the range from 0.1 to 10% by weight, in particular from 0.5 to 5% by weight, based on the total weight of the monomers to be polymerized.

In general, none, part or the entire amount of the free-radical initiator, none, part or the entire amount of the basic compound, optionally part or the entire amount of the surfactant, and optionally part or the entire amount of solketal (meth)acrylate and the optional one or more further ethylenically unsaturated monomers, are initially charged to the reaction vessel.

In preferred embodiments, the radical emulsion polymerization is carried out by adding one or more feeds containing solketal (meth)acrylate, optionally one or more further ethylenically unsaturated monomers and optionally a surfactant, one feed containing the acidic reacting polymerization initiator and one feed containing a basic compound to a reaction vessel containing the aqueous reaction medium.

In more preferred embodiments, part of the free-radical initiator, part of the basic compound, optionally part of the surfactant and optionally amount of solketal (meth)acrylate and the optional one or more further ethylenically unsaturated monomers are initially charged to the reaction vessel.

Accordingly, in more preferred embodiments, the radical emulsion polymerization is carried out by initially charging part of the free-radical initiator, part of the basic compound, optionally part of the surfactant and optionally part of solketal (meth)acrylate and the optional one or more further ethylenically unsaturated monomers to the reaction vessel, and adding one or more feeds containing the (remaining) solketal (meth)acrylate, optionally the (remaining) one or more further ethylenically unsaturated monomers and optionally the (remaining) surfactant, one feed containing the remaining acidic reacting polymerization initiator, and one feed containing the basic compound.

The present invention also concerns the polymer latices obtained by the process of the invention as well as to their use. Preferred uses of the polymer latices are the use in coatings, films, paints and diverse adhesives. Further application fields of the polymer latices are e.g. pigment printing, road marking, flooring or oil drilling fluids.

The invention is explained in more detail by the following examples.

### EXAMPLES

### Example E1

Hydrolysis Tests with Solketal Acrylate Under Acidic Conditions

5 g Solketal acrylate, 0.4 g sodium dodecyl sulfate, 0,025 g methylhydroquinone (MeHQ) and 0.025 g phenothiazine (PTZ) are mixed with 45 g deionized water and stirred. The pH value is adjusted to
a) 2.5
b) 3.8
c) 7.0

with aqueous HCl (5 wt. % solution) in case of a) and b) and with aqueous sodium bicarbonate solution (10 wt. %) in case of c). The mixture is stirred at 90° C. for 3 h. In case of c), the pH is kept at pH 7 by continuously adding droplets of aqueous sodium bicarbonate solution (10 wt. %). Afterwards, the mixture is cooled to room temperature. In case of a) and b) the pH is adjusted to pH 7 with aqueous sodium hydroxide (10 wt. % solution).

The hydrolysis degree of solketal acrylate is determined by GC analysis:

### Hydrolysis Degree:

a) >99.8%
b) >99.8%
c) <0.01%

### Example E2

Emulsion Polymerization with Solketal Acrylate Under Neutral Condition

A reactor equipped with stirrer, temperature control, nitrogen inlet and several injection possibilities is charged with 500 g deionized water, 11 g sodium lauryl sulfate and 0.4 g potassium persulfate. The reaction mixture is purged with nitrogen, heated to 85° C. and adjusted with feed 3 to pH 7. At 85° C. feed 1 is added in 80 min and feed 2 is added in 90 min. The pH is kept between pH 6.5-7.5 by continuously adding droplets of feed 3 (feed 3 does not necessarily have to be added completely). Feed 1: 350 g deionized water, 5 g sodium lauryl sulfate, 196.25 g methyl methacrylate, 196.25 g n-butyl acrylate, 392.5 g solketal acrylate. Feed 2: 3 g potassium persulfate in 60 g deionized water. Feed 3: 10 g sodium bicarbonate in 70 g deionized water. The reaction mixture is post-polymerized at 85° C. for 60 min. Then the reaction mixture is cooled down to ambient temperature.

No coagulate is observed.

### Examples E3 to E5

Emulsion Polymerization with Solketal Acrylate Under Neutral Condition

The emulsion polymerizations of E3-E5 are prepared by analogy to the protocol of E2 replacing the monomers by the respective relative amounts given in wt % (based on total monomer, BOTM) and summarized in table 1.

No coagulate is observed.

### Comparative Example C1

Emulsion Polymerization with Solketal Acrylate without pH Adjustment Under Acidic Conditions

A reactor equipped with stirrer, temperature control, nitrogen inlet and several injection possibilities is charged with 500 g deionized water, 11 g sodium lauryl sulfate and 0.4 g potassium persulfate. The reaction mixture is purged with nitrogen and heated to 85° C. At 85° C. feed 1 is added in 80 min and feed 2 is added in 90 min. Feed 1: 350 g deionized water, 5 g sodium lauryl sulfate, 196.25 g methyl methacrylate, 196.25 g n-butyl acrylate, 392.5 g solketal acrylate. Feed 2: 3 g potassium persulfate in 60 g deionized water. The reaction mixture is post-polymerized at 85° C. for 60 min. Then the reaction mixture is cooled down to ambient temperature.

Complete coagulation is observed. No dispersion is formed.

### Comparative Example C2

Emulsion Polymerization without Solketal Acrylate Under Neutral Condition

The emulsion polymerization of C2 is prepared by analogy to the protocol of E2 replacing the monomers by the respective relative amounts given in wt. % (based on total monomer, BOTM) and summarized in table 1.

No coagulate is observed.

The results of the experiments are summarized in Table 1.

TABLE 1

| | | methyl | | | |
|---|---|---|---|---|---|
| | solketal | meth- | n-butyl | residual | particle |
| | acrylate | acrylate | acrylate | monomer in | diameter of |
| | (wt % | (wt % | (wt % | the polymer | the polymer |
| | BOTM | BOTM | BOTM | dispersion | colloids |
| Example | in feed 1) | in feed 1) | in feed 1) | (ppm) | (nm) |
| E2 | 50 | 25 | 25 | <500 | 85 |
| E3 | 10 | 45 | 45 | <500 | 81 |
| E4 | 25 | 37.5 | 37.5 | <500 | 86 |
| E5 | 100 | 0 | 0 | <500 | 109 |
| C2 | 0 | 50 | 50 | <500 | 85 |

BOTM: Based on total monomer
Residual monomer content: Determined by head-space gas chromatography
Particle diameter: Determined by dynamic light scattering

1.-10. (canceled)

11. A process for preparing an aqueous polymer latex by polymerizing, optionally in the presence of a seed latex, a monomer composition containing solketal (meth)acrylate by radical emulsion polymerization in an aqueous polymerization medium in the presence of an acidic reacting radical polymerization initiator, wherein the monomer composition comprises
a) 0.1 to 100% by weight of solketal (meth)acrylate,
b) 0 to 99.9% by weight of one or more further ethylenically unsaturated monomers, characterized in that an essentially neutral pH in the range of from 6 to 8 is maintained in the aqueous polymerization medium during the radical emulsion polymerization reaction by the presence of a basic compound, wherein the acidic reacting radical polymerization initiator is a persulfate.

12. The process of claim 11, wherein the essentially neutral pH in the aqueous polymerization medium is maintained by adding a basic compound to the aqueous polymerization medium during the polymerization reaction.

13. The process of claim 12, wherein the basic compound is selected from the group consisting of water-soluble hydroxides, oxides, carbonates, hydrogen carbonates (bicarbonates),
acetates, citrates, borates, phosphates, hydrogen phosphates of alkali or alkaline earth metals or ammonium, ammonia or water-soluble organic amines.

14. The process of claim 13, wherein the basic compounds are selected from the group consisting of the hydroxides of sodium, potassium and ammonium, the carbonates of sodium and potassium and hydrogen carbonates (bicarbonates) of sodium and potassium.

15. The process of claim 11, wherein the radical emulsion polymerization is carried out in the presence of a surfactant.

16. The process of claim 11, wherein the radical emulsion polymerization is carried out by adding one or more feeds containing solketal (meth)acrylate, optionally one or more further ethylenically unsaturated monomers and optionally a surfactant, one feed containing the acidic reacting polymerization initiator, and one feed containing the basic compound, to a reaction vessel containing the aqueous reaction medium.

17. The process of claim 16, wherein part of the free-radical initiator, part of the basic compound, optionally part of the surfactant, and optionally part of solketal (meth)acrylate and the optional one or more further ethylenically unsaturated monomers, are initially charged to the reaction vessel.

18. A polymer latex obtained by the process of claim 11.

19. The use of the polymer latex of claim 18 in coatings, films, paints, adhesives and for pigment printing, road marking, flooring or oil drilling.
